(19) United States
(12) Patent Application Publication
(10) Pub. No.: US 2003/0220086 A1
(43) Pub. Date: Nov. 27, 2003

(54) Oscillator frequency offsets

(75) Inventor: Alexander Neil Birkett, Richmond (CA)

Correspondence Address: BEYER WEAVER & THOMAS LLP, P.O. BOX 778, BERKELEY, CA, 94704-0778, US

(73) Assignee: IceFyre Semiconductor Corporation

(21) Appl. No.: 10/155,107

(22) Filed: May 23, 2002

(51) Int. Cl. H04B 1/06

(52) U.S. Cl. 455/260; 455/318; 455/76

(57) ABSTRACT

Methods and devices relating to radio applications. An input signal with an input frequency is fed into a double quadrature mixer circuit along with a local oscillator signal with a local oscillator frequency. These two signals are multiplied by the mixer circuit and produces an output signal with a frequency substantially equal to either a sum of the local oscillator frequency and the input frequency or a difference of the local oscillator frequency and the input frequency. By using the quadrature mixer, the output signal consists mainly of only one sideband of the multiplication process. The carrier is mainly suppressed along with the other sideband. The output signal is particularly useful as a small frequency offset for a synthesized signal.

### FIELD OF THE INVENTION

The present invention relates to electronic circuits and, more specifically, to circuits for radio applications. It is especially but not exclusively applicable to applications relating to heterodyning and frequency synthesis.

### BACKGROUND TO THE INVENTION

The ongoing revolution in communications has led to the development of better communications technologies including a myriad of improvements in the wireless field. Wireless technology has been used for applications ranging from cellular telephones to wireless computer networks. For security and technical reasons, these wireless devices have their transmission frequencies to the gigahertz range. Unfortunately, to transmit at such high frequencies, resort has had to be made to complex circuits and methods.

As is well known in the field of radio telecommunications, a baseband signal to be transmitted is commonly upconverted to an intermediate frequency (IF) before finally being upconverted to an RF channel frequency. On the receive side, the received signal, in the RF channel frequency, is downconverted to an IF frequency and then finally to the final baseband that contains the data transmitted. Unfortunately, due to the differences in the crystals used by the receiver and the transmitter, the local oscillators in these devices must be able to compensate for differences in the carrier frequencies. Such a capability requires complex frequency synthesizers with additional loops with additional voltage controlled oscillator (VCOs). Alternatively, for time division duplex (TDD) applications, fast tuning frequency may be used. Whichever alternative is chosen, the available solutions are costly, complex, or both.

To illustrate the above issue, reference crystals used in radio transceivers have typical accuracies of about 20 parts per million. Because of this, the transmit frequency and the receive frequency for a radio unit can be quite different. For a 5 GHz link, a 200 kHz offset may result. Traditional solutions have been the use of separate fast hopping synthesizes with one synthesizer per unit in the radio link. This one synthesizer switches back and forth between the transmit and the receive frequencies for that unit. As noted above, this capability leads to complex and, invariably, costly synthesizer designs. Not only that, but this frequency hopping approach requires that the signal should be given some extra time to settle to every frequency adjustment/hop. Since one of the main issues surrounding this area is the desire to have a frequency change or frequency turn around time of less than 20 μs, this required settling time can be disadvantageous.

### SUMMARY OF THE INVENTION

The present invention provides methods and devices relating to radio applications. An input signal with an input frequency is fed into a double quadrature mixer circuit along with a local oscillator signal with a local oscillator frequency. These two signals are multiplied by the mixer circuit and produces an output signal with a frequency substantially equal to either a sum of the local oscillator frequency and the input frequency or a difference of the local oscillator frequency and the input frequency. By using the quadrature mixer, the output signal consists mainly of only one sideband of the multiplication process. The carrier is mainly suppressed along with the other sideband. The output signal is particularly useful as a small frequency offset for a synthesized signal.

In a first aspect the present invention provides a method of producing an output signal having an output frequency related to a local oscillator frequency, the method comprising:

a) feeding an input signal having an input frequency into a double quadrature mixer circuit;

b) feeding a local oscillator signal into the circuit, the local oscillator signal having the local oscillator frequency; and

c) receiving the output signal from an output of the circuit, the output signal having an output frequency substantially equal to a value chosen from a group consisting of:

a difference of the oscillator frequency subtracted from the input frequency; and

the sum of the local oscillator frequency and the input frequency.

In a second aspect, the present invention provides a method of generating frequency offsets for a frequency synthesizer, the method comprising:

a) feeding an input signal with an input frequency to an input of said frequency synthesizer;

b) generating a local oscillator signal having a local oscillator frequency;

c) feeding said local oscillator signal to a local oscillator input of said frequency synthesizer such that said local oscillator frequency is multiplied with said input frequency; and

d) producing an output signal at an output of said frequency synthesizer, said output signal having an output frequency substantially equal to a value chosen from a group consisting of:

a difference of the oscillator frequency subtracted from the input frequency; and

the sum of the local oscillator frequency and the input frequency wherein the frequency synthesizer is a double quadrature mixer.

In a third aspect the present invention provides a circuit for use in heterodyne applications, the circuit comprising:

a double quadrature mixer block having an input, a local oscillator input, and an output;

a local oscillator for generating a local oscillator signal having a local oscillator frequency;

first circuit means for sending an input signal to the mixer block said first circuit means being coupled to said input of said mixer block and said input signal having an input frequency

second circuit means for sending a local oscillator signal to said local oscillator input of said mixer block, said second circuit means being coupled to said local oscillator input;

output circuit means for receiving an output signal of said mixer block, said output circuit means being coupled to said output of said mixer block, wherein said output signal has an output frequency substantially equal to a value chosen from a group consisting of:

a difference of the oscillator frequency subtracted from the input frequency; and

the sum of the local oscillator frequency and the input frequency.

### BRIEF DESCRIPTION OF THE DRAWINGS

A better understanding of the invention will be obtained by considering the detailed description below, with reference to the following drawings in which:

FIG. 1 is a block diagram illustrating a circuit for producing offsets for frequency synthesizers according to the prior art;

FIG. 2 is a power-frequency graph of the output of the circuit in FIG. 1;

FIG. 3 is a block diagram of a circuit for providing offsets to an input signal according to one aspect of the invention;

FIG. 4 is a power-frequency graph of the components of the output signal of the circuit in FIG. 3;

FIG. 5 is a block diagram of the internal components of a double quadrature mixer for producing a specific offset output frequency with a power-frequency characteristic similar to FIG. 4;

FIG. 6 is a block diagram similar to FIG. 5 which produces a similar but different output frequency;

FIG. 7 is a power-frequency graph for the output signal of the circuit in FIG. 6; and

FIG. 8 is a block diagram similar to FIG. 5 without the quadrature splitters or combiners.

### DETAILED DESCRIPTION

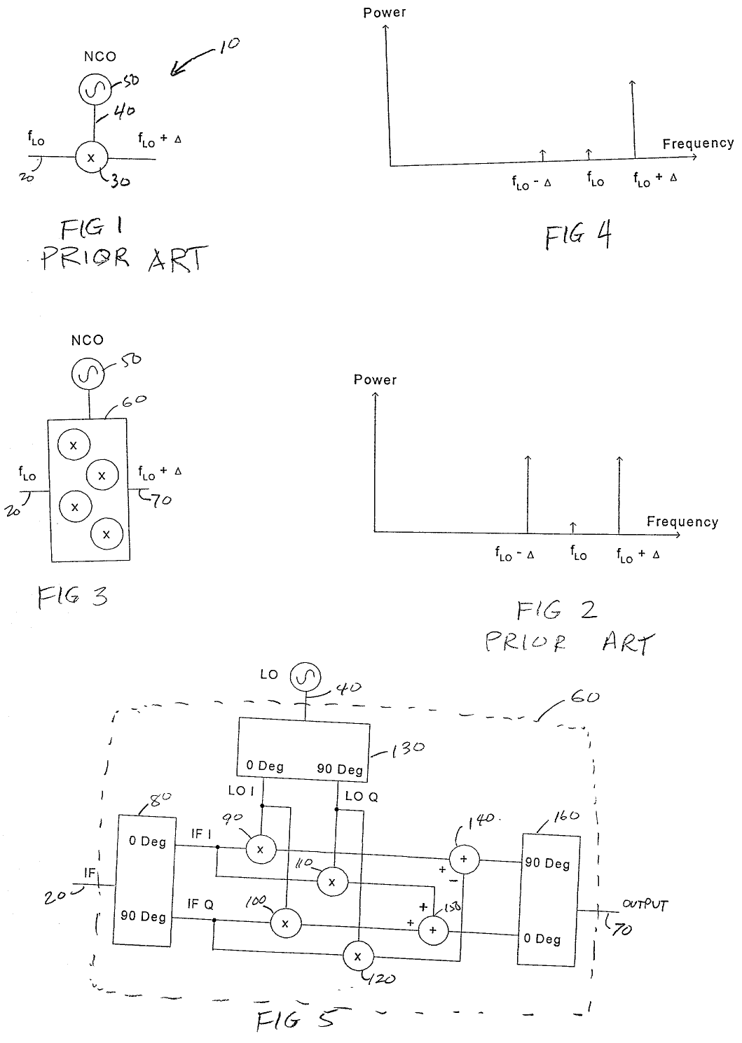

Referring to FIG. 1, a block diagram illustrating a circuit for producing offsets for frequency synthesizers according to the prior art is illustrated. An input signal is fed into the circuit 10 by way of circuit element 20. The input signal, with a frequency of f_{LO}, is received by a mixer 30 along with an oscillator signal by way of circuit element 40. The oscillator signal has an oscillator frequency of Δ and originates from a numerically controlled oscillator (NCO) 50. Circuit element 40 couples the numerically controlled oscillator (NCO) 50 to the mixer 30. The output of the circuit 10 is an output signal with an output frequency of f_{LO}+Δ. However, as FIG. 2, a power-frequency graph of the output of the circuit 10, shows, other components are present in the output signal. While the component with a frequency of f_{LO} has low power compared to the desired component with a frequency of f_{LO}+Δ, the component with a frequency of f_{LO}−Δ has a power reading substantially equal to that of the desired component.

The presence of this component with the comparable power signature to the desired component complicates matters as this component will need to be filtered out to result in only the desired component in the output.

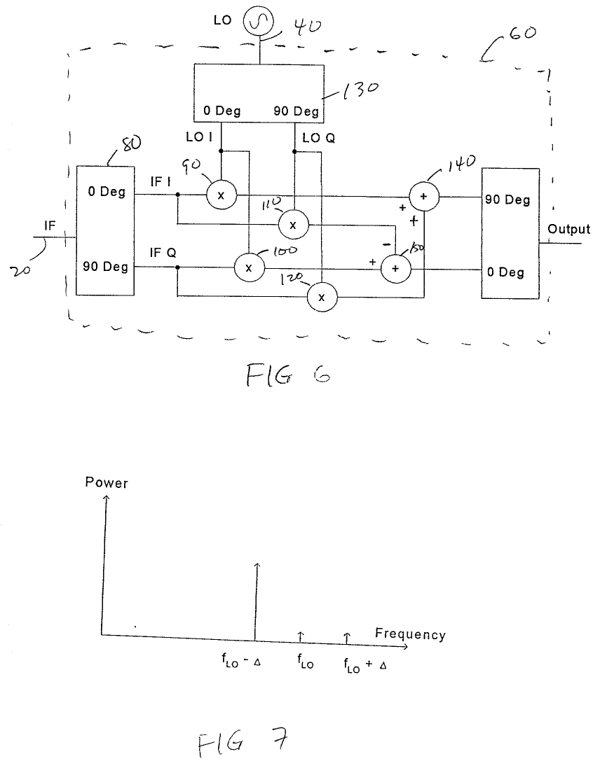

Referring to FIG. 3, a block diagram of a circuit (also known as a complex mixer) for providing offsets to an input signal is illustrated. An NCO 50 feeds an oscillator signal with an oscillator frequency of Δ to a double quadrature mixer circuit 60. The input signal has an input frequency of f_{LO} while the output signal has an output frequency of f_{LO}+Δ. FIG. 4, a power-frequency graph of the components of the output signal in FIG. 3 shows that the problems with the unwanted signal component is minimized. The power levels of the components with frequencies of f_{LO}−Δ and f_{LO} are substantially equal and are comparatively low compared to the power level of the desired component with a frequency of f_{LO}+Δ. The unwanted components thus no longer need to be filtered out. The suppression of both the carrier component, the output signal component with a frequency f_{LO}, and the unwanted sideband component, the output signal component with a frequency of f_{LO}−Δ, is due to the use of the double quadrature mixer circuit 60. While the double quadrature mixer circuit is known, its use in heterodyning operations to provide frequency offsets is not.

The double quadrature mixer circuit 60 has a number of internal components. Referring to FIG. 5, a block diagram of the internal components of a double quadrature mixer is illustrated. The double quadrature mixer 60 has an input circuit element 20 which feeds it an input signal. The double quadrature mixer also has a circuit element 40 for feeding it the oscillator signal from the NCO 50. An output circuit element 70 allows the output signal to be retrieved from the double quadrature mixer 60. A first quadrature splitter 80 receives the input signal and generates two internal signals IFI and IFQ. IFI is a copy of the input signal but IFQ is a version of the input signal that has been phase shifted by 90 degrees. It is also possible to feed IFI, IFQ, LOI, LOQ, directly without the use of the hybrid splitters 80, 160.

Also internal to the double quadrature mixer 60 are four conventional mixers 90, 100, 110, 120. First mixer 90, second mixer 100, third mixer 110, and fourth mixer 120 can be Gilbert cell mixers.

A second quadrature splitter 130 receives the oscillator signal from the NCO 50. Much like the first quadrature splitter 80, second quadrature splitter 130 generates two versions, LOI and LOQ, of the oscillator signal. LOI is a copy of the oscillator signal and LOQ is a 90 degree phase shifted version of the oscillator signal.

The signal adders/combiners 140, 150 are also internal to the quadrature mixer circuit 60. The outputs of these combiners 140, 150 are fed to a quadrature combiner 160. The output of the combiner 150 is not phase shifted when processed by the quadrature combiner 160 while the output of the combiner 140 is phase shifted by 90 degrees when processed by the quadrature combiner 160.

The first mixer 90 receives the signal IFI from the first quadrature splitter 80 along with the signal LOI from the second quadrature splitter 130. Second mixer 100 receives the signal IFQ from the first quadrature splitter 80 and the signal LOI from the second quadrature splitter 130. The third mixer 110 receives the signal IFI from the first quadrature splitter 80 and the signal LOQ from the second quadrature splitter 130. The fourth mixer 120 receives the signal IFQ from the first quadrature splitter 80 and the signal LOQ from the second quadrature splitter 130.

The adders/combiners 140, 150 combine/add the outputs of the mixers 90, 100, 110, 120 prior to passing these combined signals to the quadrature combiner 160. The first adder 140 receives and adds the negative of the output of the first mixer 90 with the output of the fourth mixer 120. The second adder 150 adds the outputs of the second mixer 100 with the output of the third mixer 110. The first adder 140 effectively subtracts the output of the fourth mixer 120 from the output of the first mixer 90. As noted above, the output of the adder 140 is fed into the 90 degree phase shifted port of the quadrature combiner 160 while the output of the adder 150 is fed into the non-phase shifted port of the quadrature combiner 160.

The output of the double quadrature mixer circuit 60 is a signal with both carrier and one sideband signals suppressed. Only the sideband with the frequency of f_{LO}+Δ has any appreciable power in the output signal. The above scheme can be used to generate small frequency offsets for synthesized signals. Thus, if a given synthesized signal has a frequency of f_{LO} but a frequency of f_{LO}+Δ is desired, with A being a small amount compared to f_{LO}, the above scheme can be used. It should be clear that the oscillator frequency of the oscillator signal is Δ.

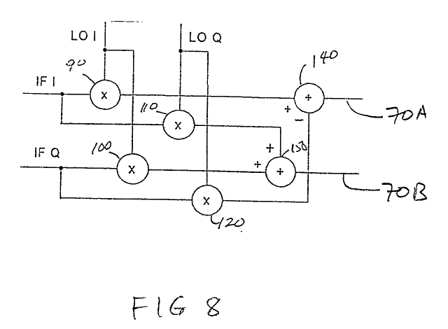

To obtain a sideband frequency of f_{LO}−Δ, a similar scheme to the above can be used. FIG. 6 illustrates the circuit for achieving this result. As can be seen, FIG. 6 is identical to FIG. 5 except that the operations performed by the adders/combiners 140, 150 have been switched. It is also possible to feed IFI, IFQ, LOI, LOQ, directly without the use of the hybrid splitters 80, 160. The signals and the components in FIGS. 5 and 6 are identical except that, in FIG. 6, first adder 140 adds the outputs of the first mixer 90 and fourth mixer 120 while the second adder 150 subtracts the output of the third mixer 110 from the output of the second mixer 100. The output of the circuit in FIG. 6 will have a power-frequency graph similar to that in FIG. 7. As can be seen in FIG. 7, the carrier and one sideband is suppressed such that the desired component with a frequency of f_{LO}−Δ is the only component with any appreciable power.

While the above description and drawings note the use of a numerically controlled oscillator, other types of oscillators may be used as long as the user's desired oscillator frequency Δ is obtained. The NCO is preferred due to its programmability, and the controllability of its output. Furthermore, the use of an NCO removes the requirement for a settling time for each frequency change. Thus, if a regular oscillator (non NCO) is used, every frequency change will require that the signal should be given time to settle or stabilize to the new frequency.

It should be noted that while the discussion above and the attached figures refers to the use of quadrature splitters 80, 130, 160, these are not necessarily required for implementation. As an example, signals IFI, IFQ, as long as they are out of phase with each other by 90 degrees, can be fed directly into the mixers 90, 100, 110, 120 without the splitter 80. Similarly, the splitter 130 can be removed as long as the signals LOI and LOQ are 90 degrees out of phase with one another.

The output 70 need not be a single signal. If the application requires a complex signal, the outputs of adder 140 and adder 150 can be used directly without the combiner block 160. As noted above, the outputs of these adders are 90 degrees out of phase with one another.

A circuit diagram of the resulting circuit without the splitters is illustrated in FIG. 8. As can be seen, the signals LOI, LOQ, IFI, IFO, are fed directly into the mixers 90, 100, 110, 120 and the outputs 70A, 70B are presented directly from the outputs of address 140, 150.

Finally, while FIG. 8 has a configuration similar to that in FIG. 5, a circuit with a configuration similar to FIG. 6, with adder 150 subtracting the results of mixer 110 from the results of mixer 100 and adder 140 adding the results of mixers 90 and 120, can also be used.

A person understanding this invention may now conceive of alternative structures and embodiments or variations of the above all of which are intended to fall within the scope of the invention as defined in the claims that follow.

We claim:

1. A method of producing an output signal having an output frequency related to a local oscillator frequency, the method comprising:
a) feeding an input signal having an input frequency into a double quadrature mixer circuit;
b) feeding a local oscillator signal into the circuit, the local oscillator signal having the local oscillator frequency; and
c) receiving the output signal from an output of the circuit, the output signal having an output frequency substantially equal to a value chosen from a group consisting of:
a difference of the oscillator frequency subtracted from the input frequency; and
the sum of the local oscillator frequency and the input frequency.

2. A method of generating frequency offsets for a frequency synthesizer, the method comprising:
a) feeding an input signal with an input frequency to an input of said frequency synthesizer;
b) generating a local oscillator signal having a local oscillator frequency;
c) feeding said local oscillator signal to a local oscillator input of said frequency synthesizer such that said local oscillator frequency is multiplied with said input frequency; and
d) producing an output signal at an output of said frequency synthesizer, said output signal having an output frequency substantially equal to a value chosen from a group consisting of:
a difference of the oscillator frequency subtracted from the input frequency; and
the sum of the local oscillator frequency and the input frequency wherein the frequency synthesizer is a double quadrature mixer.

3. A method according to claim 2 wherein the local oscillator signal is generated by a numerically controlled oscillator.

4. A circuit for use in heterodyne applications, the circuit comprising:
a double quadrature mixer block having an input, a local oscillator input, and at least one output;
a local oscillator for generating a local oscillator signal having a local oscillator frequency;
first circuit means for sending an input signal to the mixer block said first circuit means being coupled to said input of said mixer block and said input signal having an input frequency
second circuit means for sending a local oscillator signal to said local oscillator input of said mixer block, said second circuit means being coupled to said local oscillator input;
output circuit means for receiving at least one output signal of said mixer block, said output circuit means being coupled to said at least one output of said mixer block, wherein said at least one output signal has an output frequency substantially equal to a value chosen from a group consisting of:
a difference of the oscillator frequency subtracted from the input frequency; and
the sum of the local oscillator frequency and the input frequency.

5. A circuit according to claim 4 wherein said value is a difference of the oscillator frequency subtracted from the input frequency and said mixer block comprises:
a first quadrature splitter receiving the input signal and producing a first internal signal and a second internal signal, each being derived from said input signal with the second internal signal being 90 degrees out of phase from the first internal signal;
a second quadrature splitter receiving the local oscillator signal and producing a first internal oscillator signal and a second internal oscillator signal, each being derived from the local oscillator signal with the second internal oscillator signal being 90 degrees out of phase from the first internal oscillator signal;
a first mixer receiving and mixing the first internal signal and the first internal oscillator signal;
a second mixer receiving and mixing the second internal signal and the first internal oscillator signal;
a third mixer receiving and mixing the first internal signal and the second internal oscillator signal;
a fourth mixer receiving and mixing the second internal signal and the second internal oscillator signal;
a first adder receiving and adding an output of the first mixer and an output of the fourth mixer;
a second adder receiving an output of the second mixer and an output of the third mixer, said second adder subtracting the output of the third mixer from the output of the second mixer;
a quadrature combiner receiving and combining outputs of the first adder and of the second adder to produce said output signal.

6. A circuit according to claim 4 wherein said local oscillator is a numerically controlled oscillator.

7. A method according to claim 2 wherein said frequency synthesizer comprises:
a double quadrature mixer block having an input, a local oscillator input, and an output;
a local oscillator for generating a local oscillator signal having a local oscillator frequency;
first circuit means for sending an input signal to the mixer block said first circuit means being coupled to said input of said mixer block and said input signal having an input frequency second circuit means for sending a local oscillator signal to said local oscillator input of said mixer block, said second circuit means being coupled to said local oscillator input; and
output circuit means for receiving an output signal of said mixer block, said output circuit means being coupled to said output of said mixer block.

8. A method according to claim 1 wherein said value is a difference of the oscillator frequency subtracted from the input frequency and said double quadrature mixer circuit comprises:
a first quadrature splitter receiving the input signal and producing a first internal signal and a second internal signal, each being derived from said input signal with the second internal signal being 90 degrees out of phase from the first internal signal;
a second quadrature splitter receiving the local oscillator signal and producing a first internal oscillator signal and a second internal oscillator signal, each being derived from the local oscillator signal with the second internal oscillator signal being 90 degrees out of phase from the first internal oscillator signal;
a first mixer receiving and mixing the first internal signal and the first internal oscillator signal;
a second mixer receiving and mixing the second internal signal and the first internal oscillator signal;
a third mixer receiving and mixing the first internal signal and the second internal oscillator signal;
a fourth mixer receiving and mixing the second internal signal and the second internal oscillator signal;
a first adder receiving and adding an output of the first mixer and an output of the fourth mixer;
a second adder receiving an output of the second mixer and an output of the third mixer, said second adder subtracting the output of the third mixer from the output of the second mixer;
a quadrature combiner receiving and combining outputs of the first adder and of the second adder to produce said output signal.

9. A circuit according to claim 4 wherein said value is a sum of the oscillator frequency and of the input frequency and said mixer block comprises:
a first quadrature splitter receiving the input signal and producing a first internal signal and a second internal signal, each being derived from said input signal with the second internal signal being 90 degrees out of phase from the first internal signal;
a second quadrature splitter receiving the local oscillator signal and producing a first internal oscillator signal and a second internal oscillator signal, each being derived from the local oscillator signal with the second internal oscillator signal being 90 degrees out of phase from the first internal oscillator signal;
a first mixer receiving and mixing the first internal signal and the first internal oscillator signal;
a second mixer receiving and mixing the second internal signal and the first internal oscillator signal;
a third mixer receiving and mixing the first internal signal and the second internal oscillator signal;
a fourth mixer receiving and mixing the second internal signal and the second internal oscillator signal;
a first adder receiving an output of the first mixer and an output of the fourth mixer, said first adder subtracting the output of the fourth mixer from the output of the first mixer;
a second adder receiving and adding an output of the second mixer and an output of the third mixer;
a quadrature combiner receiving and combining outputs of the first adder and of the second adder to produce said output signal.

10. A method according to claim 1 wherein said value is a sum of the oscillator frequency and of the input frequency and said double quadrature mixer circuit comprises:
a first quadrature splitter receiving the input signal and producing a first internal signal and a second internal signal, each being derived from said input signal with the second internal signal being 90 degrees out of phase from the first internal signal;
a second quadrature splitter receiving the local oscillator signal and producing a first internal oscillator signal and a second internal oscillator signal, each being derived from the local oscillator signal with the second internal oscillator signal being 90 degrees out of phase from the first internal oscillator signal;
a first mixer receiving and mixing the first internal signal and the first internal oscillator signal;
a second mixer receiving and mixing the second internal signal and the first internal oscillator signal;
a third mixer receiving and mixing the first internal signal and the second internal oscillator signal;
a fourth mixer receiving and mixing the second internal signal and the second internal oscillator signal;
a first adder receiving an output of the first mixer and an output of the fourth mixer, said first adder subtracting the output of the fourth mixer from the output of the first mixer;
a second adder receiving and adding an output of the second mixer and an output of the third mixer;
a quadrature combiner receiving and combining outputs of the first adder and of the second adder to produce said output signal.

11. A method according to claim 1, wherein said value is a difference of the oscillator frequency subtracted from the input frequency and said double quadrature mixer circuit comprises:
a first mixer receiving and mixing a first internal signal and a first internal oscillator signal;
a second mixer receiving and mixing a second internal signal and the first internal oscillator signal;
a third mixer receiving and mixing the first internal signal and a second internal oscillator signal;
a fourth mixer receiving and mixing a second internal signal and the second internal oscillator signal;
a first adder receiving and adding an output of the first mixer and an output of the fourth mixer;
a second adder receiving an output of the second mixer and an output of the third mixer, said second adder subtracting the output of the third mixer from the output of the second mixer, wherein
said first internal signal is 90 degrees out of phase from said second internal signal and both first internal signal and second internal signal are derived from the input signal;
the first internal oscillator signal is 90 degrees out of phase from the second internal oscillator signal and both first internal oscillator signal and second internal oscillator signal are derived from the local oscillator signal; and
said output signal is derived from the outputs of the first adder and the second adder.

12. A method according to claim 1, wherein said value is a sum of the oscillator frequency subtracted from the input frequency and said double quadrature mixer circuit comprises:
a first mixer receiving and mixing a first internal signal and a first internal oscillator signal;
a second mixer receiving and mixing a second internal signal and the first internal oscillator signal;
a third mixer receiving and mixing the first internal signal and a second internal oscillator signal;
a fourth mixer receiving and mixing a second internal signal and the second internal oscillator signal;
a first adder receiving an output of the first mixer and an output of the fourth mixer, said first adder subtracting the output of the fourth mixer from the output of the fist mixer;
a second adder receiving and adding an output of the second mixer and an output of the third mixer, wherein
said first internal signal is 90 degrees out of phase from said second internal signal and both first internal signal and second internal signal are derived from the input signal;
the first internal oscillator signal is 90 degrees out of phase from the second internal oscillator signal and both first internal oscillator signal and second internal oscillator signal are derived from the local oscillator signal; and
said output signal is derived from the outputs of the first adder and the second adder.

13. A circuit according to claim 4, wherein said value is a difference of the oscillator frequency subtracted from the input frequency and said double quadrature mixer circuit comprises:
a first mixer receiving and mixing a first internal signal and a first internal oscillator signal;
a second mixer receiving and mixing a second internal signal and the first internal oscillator signal;
a third mixer receiving and mixing the first internal signal and a second internal oscillator signal;
a fourth mixer receiving and mixing a second internal signal and the second internal oscillator signal;
a first adder receiving and adding an output of the first mixer and an output of the fourth mixer;
a second adder receiving an output of the second mixer and an output of the third mixer, said second adder subtracting the output of the third mixer from the output of the second mixer, wherein
said first internal signal is 90 degrees out of phase from said second internal signal and both first internal signal and second internal signal are derived from the input signal;
the first internal oscillator signal is 90 degrees out of phase from the second internal oscillator signal and both first internal oscillator signal and second internal oscillator signal are derived from the local oscillator signal; and
said at least one output signal comprises an output of the first adder and an output of the second adder.

14. A circuit according to claim 4, wherein said value is a sum of the oscillator frequency subtracted from the input frequency and said double quadrature mixer circuit comprises:
a first mixer receiving and mixing a first internal signal and a first internal oscillator signal;
a second mixer receiving and mixing a second internal signal and the first internal oscillator signal;
a third mixer receiving and mixing the first internal signal and a second internal oscillator signal;
a fourth mixer receiving and mixing a second internal signal and the second internal oscillator signal;
a first adder receiving an output of the first mixer and an output of the fourth mixer, said first adder subtracting the output of the fourth mixer from the output of the fist mixer;
a second adder receiving and adding an output of the second mixer and an output of the third mixer, wherein
said first internal signal is 90 degrees out of phase from said second internal signal and both first internal signal and second internal signal are derived from the input signal;
the first internal oscillator signal is 90 degrees out of phase from the second internal oscillator signal and both first internal oscillator signal and second internal oscillator signal are derived from the local oscillator signal; and
said at least one output signal comprises an output of the first adder and an output of the second adder.
